(19) United States
(12) Patent Application Publication
(10) Pub. No.: US 2025/0149700 A1
(43) Pub. Date: May 8, 2025

(54) BATTERY MODULE

(71) Applicant: TOYOTA JIDOSHA KABUSHIKI KAISHA, Toyota-shi (JP)

(72) Inventors: Kota OHATA, Toyota-shi (JP); Masahiro ISHIZUKA, Toyota-shi (JP); Hajime HASEGAWA, Aichi-gun (JP); Mitsuru TATEISHI, Toyota-shi (JP); Norihiro OSE, Nagoya-shi (JP); Masashi CHIHARA, Nagoya-shi (JP)

(21) Appl. No.: 18/900,915

(22) Filed: Sep. 30, 2024

(30) Foreign Application Priority Data
Nov. 6, 2023 (JP) 2023-189638

(51) Int. Cl. H01M 50/209; H01M 50/249

(52) U.S. Cl. CPC H01M 50/209; H01M 50/249; H01M 2220/20

(57) ABSTRACT

An inner surface of a connection portion that connects end portions of a first wall and a second wall, which are adjacent to each other, of a case, is a curved surface that is convex towards a space side, at least a part of the curved surface is a curvature changing portion at which a radius of curvature gradually decreases from a first wall side toward a second wall side, and a battery cell that is positioned furthest toward the first wall side includes a portion that contacts the curvature changing portion.

### CROSS-REFERENCE TO RELATED APPLICATION

This application is based on and claims priority under 35 USC 119 from Japanese Patent Application No. 2023-189638, filed on Nov. 6, 2023, the entire disclosure of which is incorporated by reference herein.

### BACKGROUND

### Technical Field

The present disclosure relates to a battery module.

### Related Art

Japanese National Phase Publication (JP-A) No. 2021-509524 discloses a battery module including a battery cell laminated body configured by laminating plural laminate type battery cells, and a case in which the battery cell stack laminated body is accommodated. The case includes an upper wall portion, a lower wall portion, and a peripheral wall portion that connects outer peripheral portions of the upper wall portion and the lower wall portion. Further, the peripheral wall portion includes a pair of first walls, and a pair of second walls that are orthogonal to the pair of first walls and that are connected to the pair of first walls. Each battery cell is side-by-side along a direction in which the pair of first walls face each other.

The aforementioned case may include four connection portions that connect end portions of a first wall and a second wall that are adjacent to each other, and that protrude toward a space side inside the case. In such a case, a longitudinal direction end portion of a battery cell facing the first wall may interfere with the connection portion, and this end portion may be significantly deformed due to contact with the connection portion.

In consideration of the above circumstances, an object of the present disclosure is to obtain a battery module that is capable of reducing an amount of deformation of a battery cell in a case in which a laminated battery cell has contacted a connection portion that connects end portions of a first wall and a second wall of a case to each other.

### SUMMARY

A battery module according to a first aspect includes: a case that includes a pair of first walls that are separated in a predetermined first direction, a pair of second walls that are separated in a second direction that is orthogonal to the first direction, and four connection portions that respectively connect end portions of adjacent ones of the pair of first walls and the pair of second walls; and a plurality of laminated battery cells that are accommodated, in a state of being side-by-side in the first direction, in a space enclosed by the pair of first walls, the pair of second walls, and each of the connection portions, and that extend along the second direction, wherein an inner surface of each connection portion is a curved surface that is convex toward the space when viewing the case along an orthogonal direction that is orthogonal to the first direction and the second direction, and at least a part of the curved surface is a curvature changing portion at which a radius of curvature gradually decreases from the first wall side toward the second wall side, and wherein a battery cell that is positioned furthest toward the first wall side includes a portion that contacts the curvature changing portion when viewing the case along the orthogonal direction.

The inner surface of the connection portion of the battery module according to the first aspect is a curved surface that is convex toward the space side when viewing the case along the orthogonal direction that is orthogonal to the first direction and the second direction. Further, at least a part of the curved surface is a curvature changing portion at which the radius of curvature gradually decreases from the first wall side toward the second wall side. Furthermore, the battery cell that is positioned furthest toward the first wall side includes a portion that contacts the curvature changing portion when viewing the case along the orthogonal direction. Therefore, the battery module according to the first aspect enables an amount of deformation of the thickness changing portion to be reduced in a case in which the laminated type battery cell has contacted a connection portion of the case. Accordingly, in a case in which the laminated battery cell has contacted a connection portion, the amount of deformation of the battery cell is reduced.

A battery module according to a second aspect is the battery module according to the first aspect, wherein: the portion of the battery cell that is positioned furthest toward the first wall side, which contacts the curvature changing portion, is a thickness changing portion having a thickness that decreases toward the second wall side when viewing the case along the orthogonal direction.

In the battery module according to the second aspect, by configuring such that the portion that is in contact with the curvature changing portion is a thickness changing portion, the amount of deformation of the battery cell decreases in a case in which the laminated battery cell has contacted a connection portion.

A battery module according to a third aspect is the battery module according to the first aspect, wherein: a size of the radius of curvature at a predetermined portion of the curved surface is greater than or equal to a dimension obtained by multiplying a thickness of the portion of the battery cell which contacts the predetermined portion by 0.5.

In the battery module according to the third aspect, the amount of deformation of the thickness changing portion is easily reduced.

A battery module according to a fourth aspect is the battery module according to any one of the first aspect to the third aspect, wherein: an entirety of the curved surface is the curvature changing portion.

In the battery module according to the fourth aspect, the amount of deformation of the thickness changing portion is easily reduced.

As explained above, the battery module according to the present disclosure has an excellent advantageous effect of enabling the amount of deformation of a battery cell to be reduced in a case in which the laminated battery cell has contacted a connection portion that connects the end portions of a first wall and a second wall of the case.

### BRIEF DESCRIPTION OF THE DRAWINGS

Exemplary embodiments of the present disclosure will be described in detail based on the following figures, wherein:

FIG. 1 is a bottom view of a vehicle to which a battery module according to an exemplary embodiment has been applied;

FIG. 2 is a perspective view of a battery module;

FIG. 3 is an exploded perspective view of a case of a battery module;

FIG. 4 is a plan view of a case main body, a battery cell, a cushioning material, and a flexible printed circuit board;

FIG. 5 is a side view of a battery cell;

FIG. 6 is a view taken along a width direction of a laminate including a positive electrode sheet, a negative electrode sheet, and two separators; and

FIG. 7 is a plan view of a case main body, a battery cell positioned at a frontmost side, and a portion of a cushioning material at a front side.

### DETAILED DESCRIPTION

### Overall Configuration of Vehicle 100

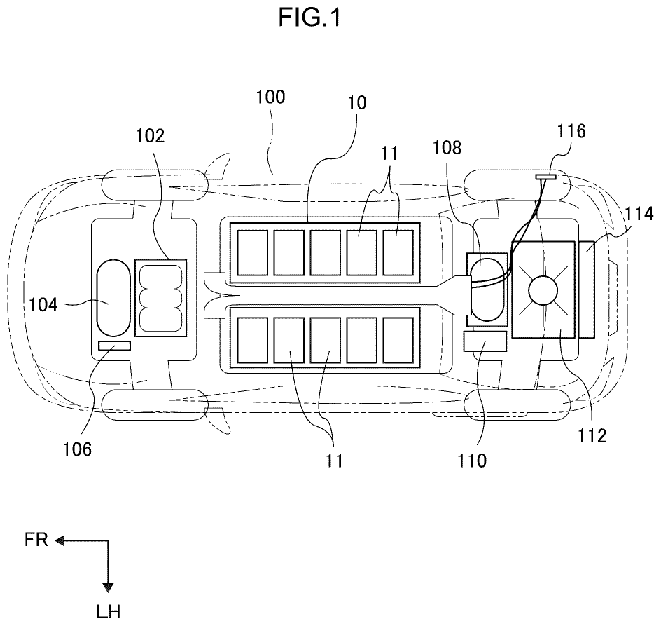

FIG. 1 is a schematic plan view illustrating a main part of a vehicle 100 to which a battery pack 10 according to an exemplary embodiment has been applied. As illustrated in FIG. 1, the vehicle 100 is an electric vehicle (battery electric vehicle (BEV)) at which the battery pack 10 is installed under a floor. It should be noted that in each of the drawings, the arrow UP, the arrow FR, and the arrow LH respectively indicate an upper side in a vehicle up-down direction, a front side in a vehicle front-rear direction, and a left side in a vehicle width direction. Unless specifically stated otherwise, in a case in which front-rear, left-right, and up-down directions are described, these refer to the front and rear in the vehicle front-rear direction, the left and right in the vehicle width direction, and up and down in a vehicle up-down direction.

As an example, in the vehicle 100 of the present exemplary embodiment, a DC/DC converter 102, an electric compressor 104, and a positive temperature coefficient (PTC) heater 106 are disposed further to a vehicle front side than the battery pack 10. Further, a motor 108, a gear box 110, an inverter 112, and a charger 114 are disposed further to a vehicle rear side than the battery pack 10.

The DC current that has been output from the battery pack 10 is adjusted in voltage by the DC/DC converter 102, and then is supplied to the electric compressor 104, the PTC heater 106, the inverter 112, and the like. Further, by electric power being supplied to the motor 108 via the inverter 112, the rear wheels rotate to drive the vehicle 100.

A charging port 116 is provided at a right side portion of a rear portion of the vehicle 100, and by connecting a charging plug of an external charging facility, which is not illustrated in the drawings, from the charging port 116, electric power can be stored in the battery pack 10 via the in-vehicle charger 114.

It should be noted that an arrangement, structure and the like of the respective components configuring the vehicle 100 are not limited to the above-described configuration. For example, the present disclosure may be applied to a hybrid vehicle (HV) or a plug-in hybrid vehicle (plug-in hybrid electric vehicle (PHEV)) at which an engine is installed. Further, in the present exemplary embodiment, although the vehicle is configured as a rear-wheel-drive vehicle in which the motor 108 is installed at a rear portion of the vehicle, there is no limitation thereto, and the vehicle may be configured as a front-wheel-drive vehicle in which the motor 108 is installed at a front portion of the vehicle, and a pair of motors 108 may also be installed at the front and rear of the vehicle. Furthermore, the vehicle may also be provided with in-wheel motors at the respective wheels.

In this regard, the battery pack 10 includes plural battery modules 11. In the present exemplary embodiment, as an example, ten battery modules 11 are provided. Specifically, five battery modules 11 are arranged in the vehicle front-rear direction at the right side of the vehicle 100, and five battery modules 11 are arranged in the vehicle front-rear direction at the left side of the vehicle 100. Further, each of the battery modules 11 is electrically connected to each other.

A pair of voltage terminals 12 and a connector 14 are provided at both vehicle width direction end portions of the battery module 11. A flexible printed circuit board 70, which is described below, is connected to the connector 14. Furthermore, bus bars, which are not illustrated in the drawings, are welded to both vehicle width direction end portions of the battery module 11.

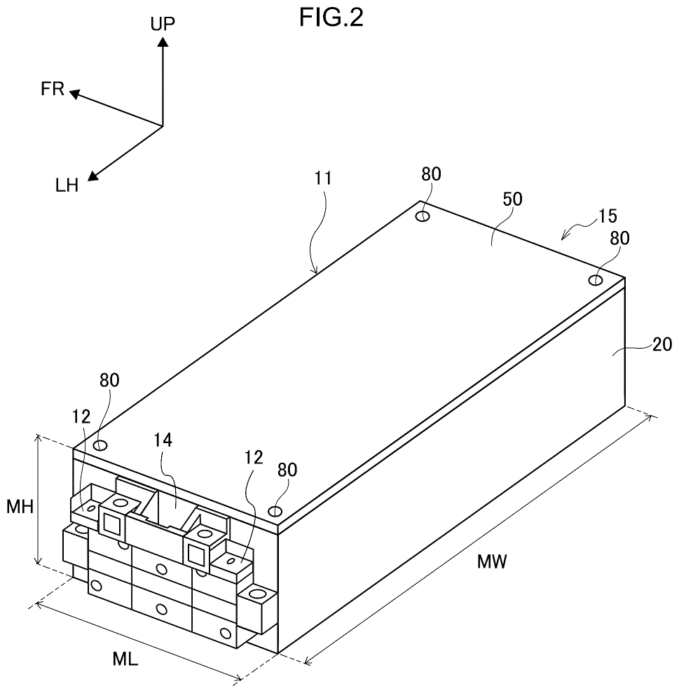

As illustrated in FIG. 1 and FIG. 2, each battery module 11 is formed in a substantially rectangular parallelepiped shape having a longitudinal direction along the vehicle width direction. A case 15 that configures the outer shape of the battery module 11 is formed of an aluminum alloy. The case 15 includes a case main body 20 and a lid body 50.

A length MW of the battery module 11 in the vehicle width direction is, for example, from 350 mm to 600 mm, a length ML thereof in the vehicle front-rear direction is, for example, from 150 mm to 250 mm, and a height MH thereof in the vehicle up-down direction is, for example, from 80 mm to 110 mm.

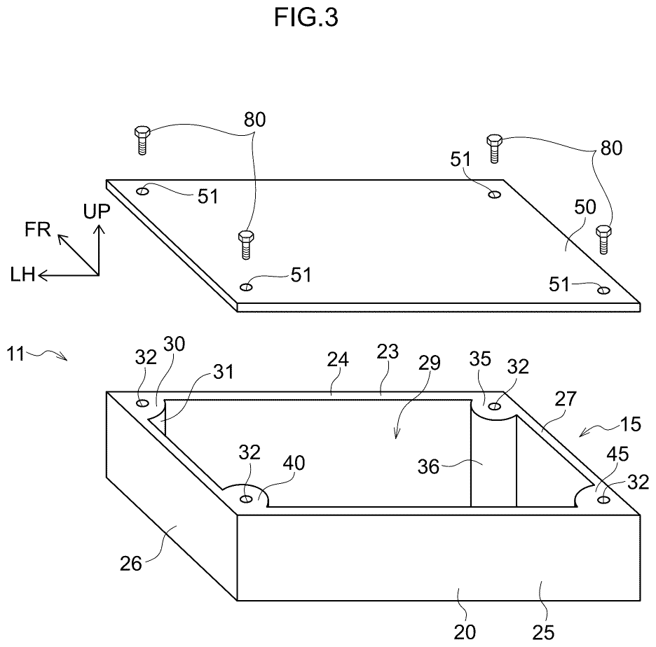

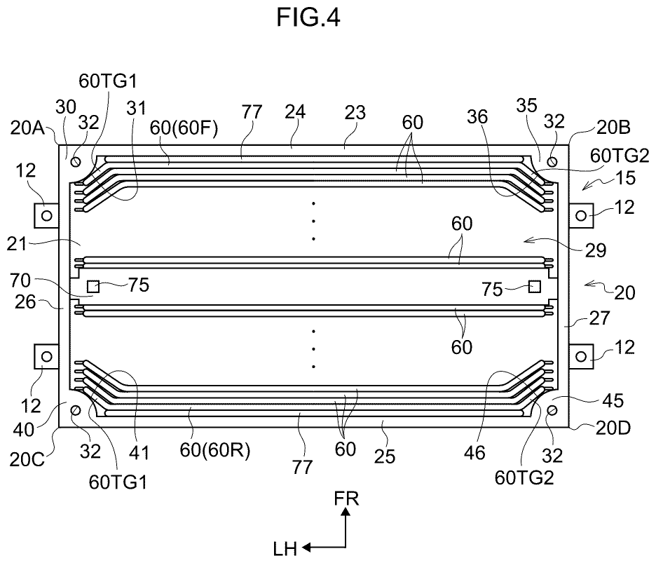

As illustrated in FIG. 3 and FIG. 4, the case main body 20 is an integrally molded article including a bottom wall portion 21 having a rectangular planar shape, a peripheral wall portion 23 connected to an outer peripheral edge portion of an upper surface of the bottom wall portion 21, and four connection portions 30, 35, 40, and 45. Further, the peripheral wall portion 23 includes a front wall portion (first wall) 24, a rear wall portion (first wall) 25, a left side wall portion (second wall) 26, and a right side wall portion (second wall) 27. In plan view, the front wall portion 24 and the rear wall portion 25 are parallel to the left-right direction (a second direction), and face each other in the front-rear direction (a first direction). In plan view, the left side wall portion 26 and the right side wall portion 27 are parallel to the front-rear direction (the first direction), and face each other in the left-right direction (the second direction).

The connection portion 30 is provided between a left end portion of the front wall portion 24 and a front end portion of the left side wall portion 26, and the connection portion 35 is provided between a right end portion of the front wall portion 24 and a front end portion of the right side wall portion 27. Further, the connection portion 40 is provided between a left end portion of the rear wall portion 25 and a rear end portion of the left side wall portion 26, and the connection portion 45 is provided between a right end portion of the rear wall portion 25 and a rear end portion of the right side wall portion 27. Lower ends of the connection portions 30, 35, 40, and 45 are connected to the bottom wall portion 21. Further, upper surfaces of the connection portions 30, 35, 40, and 45 and an upper surface of the peripheral wall portion 23 are planes that are continuous with each other and that are orthogonal to the up-down direction (an orthogonal direction). Plural laminated battery cells 60 are accommodated in a space 29 that is enclosed by the bottom wall portion 21 and the peripheral wall portion 23.

Inner surfaces 31, 36, 41, and 46, which are surfaces facing the space 29 of the connection portions 30, 35, 40, and 45, are configured by curved surfaces that are convex toward a space 29 side when viewed in the up-down direction (the orthogonal direction).

As illustrated in FIG. 7, a radius of curvature RP of the inner surface 31 of the connection portion 30 which is centered on a corner portion 20A at which the front wall portion 24 and the left side wall portion 26 intersect with each other, when viewed along the up-down direction, gradually decreases from a front wall portion 24 side toward a left side wall portion 26 side. Similarly, a radius of curvature of the inner surface 36 of the connection portion 35 which is centered on a corner portion 20B at which the front wall portion 24 and the right side wall portion 27 intersect with each other, when viewed along the up-down direction, gradually decreases from the front wall portion 24 side toward a right side wall portion 27 side. A radius of curvature of the inner surface 41 of the connection portion 40 which is centered on a corner portion 20C at which the rear wall portion 25 and the left side wall portion 26 intersect with each other, when viewed along the up-down direction, gradually decreases from a rear wall portion 25 side toward the left side wall portion 26 side. A radius of curvature of the inner surface 46 of the connection portion 45 which is centered on a corner portion 20D at which the rear wall portion 25 and the right side wall portion 27 intersect with each other, when viewed along the up-down direction, gradually decreases from the rear wall portion 25 side toward the right side wall portion 27 side. Namely, an entirety of the inner surface 31, an entirety of the inner surface 36, an entirety of the inner surface 41, and an entirety of the inner surface 46 are each configured by a curvature changing portion.

As illustrated in FIG. 2 and FIG. 3, the lid body 50 is configured by a plate member having a rectangular shape. A through hole 51 is formed at each of the four corner portions of the lid body 50.

As illustrated in FIG. 4, plural battery cells 60 are accommodated at an interior of the battery case 20 in an arranged state. In the present exemplary embodiment, as an example, 24 battery cells 60 are arranged in the vehicle front-rear direction and are adhered to each other (only some of the battery cells 60 are illustrated in FIG. 4).

A flexible printed circuit (FPC) board 70 is disposed on the battery cells 60. The flexible printed circuit board 70 is formed in a band shape with a longitudinal direction thereof along the vehicle width direction, and thermistors 75 are respectively provided at both end portions of the flexible printed circuit board 70. The thermistors 75 are not adhered to the battery cells 60 and are configured so to be pressed toward a battery cells 60 side by the lid body 50.

As illustrated in FIG. 4, a cushioning material 77 facing an inner surface of the front wall portion 24 and a cushioning material 77 facing an inner surface of the rear wall portion 25 are accommodated at an interior of the case main body 20. Thickness directions of the two cushioning materials 77 coincide with an arrangement direction (lamination direction) of the battery cells 60. For example, the cushioning material 77 is a thin plate-shaped member that is elastically deformable.

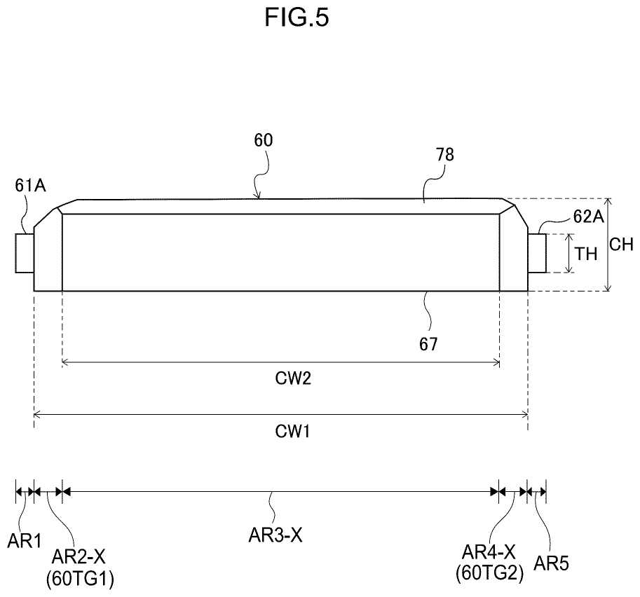

FIG. 5 is a schematic view of a battery cell 60 that is accommodated in a battery module 11, viewed from a thickness direction of the battery cell 60. As is apparent from FIG. 4 and FIG. 5, the battery cell 60 is formed in a substantially rectangular plate shape.

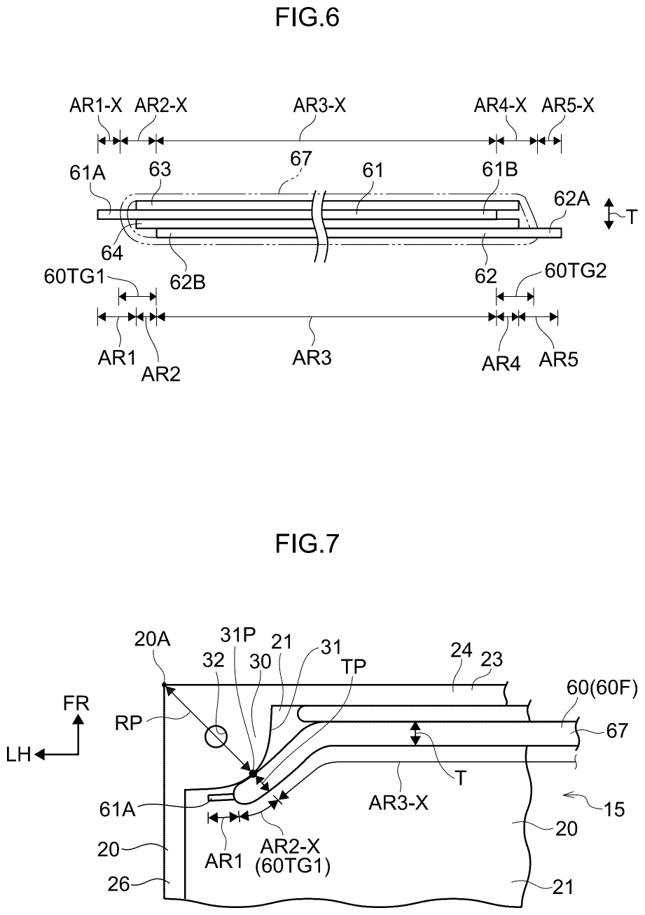

As illustrated in FIG. 5 to FIG. 7, the battery cell 60 includes a positive electrode sheet 61, a negative electrode sheet 62, separators 63 and 64, and a laminate film 67. The battery cell 60 has a structure in which a laminated body, which includes the positive electrode sheet 61, the negative electrode sheet 62, and the separators 63 and 64, is covered with the laminate film 67. As illustrated in FIG. 6, the positive electrode sheet 61 is sandwiched between the separator 63 and the separator 64, and the separator 64 is sandwiched between the positive electrode sheet 61 and the negative electrode sheet 62. The positive electrode sheet 61, the negative electrode sheet 62, and the separators 63 and 64 are members having elongated band-like flexibility extending along a predetermined direction (the left-right direction in FIG. 6). The positive electrode sheet 61 includes an elongated band-shaped positive electrode body, and a positive electrode active material that is coated on both surfaces of the positive electrode body. However, the positive electrode active material is not coated at a positive electrode terminal 61A, which is one end portion of the positive electrode body. The negative electrode sheet 62 includes an elongated band-shaped negative electrode body, and a negative electrode active material that is coated on both surfaces of the negative electrode body. However, the negative electrode active material is not coated at a negative electrode terminal 62A, which is one end portion of the negative electrode body. The positive electrode terminal 61A and the negative electrode terminal 62A protrude from end portions of the separators 63 and 64. Further, an end portion 61B of the positive electrode sheet 61, which is at the opposite side to the positive electrode terminal 61A, is positioned further toward a positive electrode terminal 61A side than end portions of the separators 63 and 64 at a negative electrode terminal 62A side. An end portion 62B of the negative electrode sheet 62, which is at the opposite side to the negative electrode terminal 62A, is positioned further toward the negative electrode terminal 62A side than end portions of the separators 63 and 64 at the positive electrode terminal 61A side.

As illustrated in FIG. 6, a region that is configured by the positive electrode terminal 61A of the above-described laminated body is defined as a first region AR1, a region that is configured by a portion of the separators 63 and 64 which is further toward the positive electrode terminal 61A side than the end portion 62B is defined as a second region AR2, a region that is configured by the positive electrode sheet 61, the negative electrode sheet 62, and the separators 63 and 64 is defined a a third region AR3, a region that is configured by a portion of the separators 63 and 64 which is further toward the negative electrode terminal 62A side than the end portion 61B is defined as a fourth region AR4, and a region that is configured by the negative electrode terminal 62A is defined as a fifth region AR5. In this case, a thickness T of the above-described laminated body (see FIG. 6 and FIG. 7) has a relationship of: the first region AR1, the fifth region AR5<the second region AR2, the fourth region AR4<the third region AR3.

The laminated body that includes the positive electrode sheet 61, the negative electrode sheet 62, and the separators 63 and 64 is folded or wound 99 times, and is sealed by the laminate film 67 that covers the laminated body in this state from the outer peripheral side. In the present exemplary embodiment, as an example, the embossed sheet-shaped laminate film 67 is folded and bonded together to thereby form a housing portion of a part other than part of the positive electrode terminal 61A and other than part of the negative electrode terminal 62A of the laminated body. It should be noted that although both a single-cup embossing structure in which embossing is at one location and a double-cup embossing structure in which embossing is at two locations can be adopted, in the present exemplary embodiment, a single-cup embossing structure having a draw depth of from about 8 mm to about 10 mm is adopted.

The upper ends of both longitudinal direction end portions of the battery cell 60 are bent, and the corners thereof form an outer shape. Further, the upper end portions of the battery cell 60 are bent, and a fixing tape 78 is wound around the upper end portions of the battery cell 60 along the longitudinal direction.

As illustrated in FIG. 5 and FIG. 6, a portion of the positive electrode terminal 61A and a portion of the negative electrode terminal 62A respectively protrude from both longitudinal direction end portions of the laminate film 67. In the present exemplary embodiment, as an example, the positive electrode terminal 61A and the negative electrode terminal 62A are provided at positions that are offset downward from a center of the battery cell 60 in the up-down direction. The positive electrode terminal 61A and the negative electrode terminal 62A are joined to bus bars, which are not illustrated in the drawings, by laser welding or the like. Further, a region of the battery cell 60 which protrudes from the laminate film 67 at the positive electrode terminal 61A is defined as a first region AR1-X, and a region of the battery cell 60 which protrudes from the laminate film 67 at the negative electrode terminal 62A is defined as a fifth region AR5-X. Furthermore, a region of the laminate film 67 positioned between the first region AR1-X and the third region AR3 is defined as a second region AR2-X, a region corresponding to the third region AR3 is defined as a third region AR3-X, and a region positioned between the fifth region AR5-X and the third region AR3-X is defined at a fourth region AR4-X. In this case, thicknesses T of the first region AR1-X, the second region AR2-X, the third region AR3-X, the fourth region AR4-X, and the fifth region AR5-X have a relationship of: the first region AR1-X, the fifth region AR5-X<the second region AR2-X, the fourth region AR4-X<the third region AR3-X. Further, as illustrated in FIG. 5 and FIG. 6, a portion corresponding to the second region AR2-X of the battery cell 60 is a thickness changing portion 60TG1, and a portion corresponding to the fourth region AR4-X of the battery cell 60 is a thickness changing portion 60TG2. The thickness changing portion 60TG1 is a portion at which the thickness T decreases toward the left side (the positive electrode terminal 61A side), and the thickness changing portion 60TG2 is a portion at which the thickness T decreases toward the right side (the negative electrode terminal 62A side).

As illustrated in FIG. 5, a length CW1 in the vehicle width direction of the battery cell 60 is, for example, from 530 mm to 600 mm, a length CW2 of the third region AR3 of the above-described laminated body is, for example, from 500 mm to 520 mm, and a height (a width direction dimension) CH of the battery cell 60 is, for example, from 80 mm to 110 mm. Further, a thickness of the battery cell 60 is from 7.0 mm to 9.0 mm, and a height TH of the positive electrode terminal 61A and the negative electrode terminal 62A is from 40 mm to 50 mm.

As illustrated in FIG. 2, the lid body 50 is placed over the upper surface of the case main body 20 that accommodates the battery cell 60, the flexible printed circuit board 70, and the fixing tape 78, screws 80 are inserted into the four through holes 51 of the lid body 50 from above, and the male screw grooves of each screw 80 are screwed into the corresponding female screw holes 32. Therefore, an outer peripheral portion of a lower surface of the lid body 50 is in close contact with an upper end surface of the case main body 20.

As illustrated in FIG. 4, 24 battery cells 60 are accommodated at the interior of the case main body 20 side-by-side in the vehicle front-rear direction, and 24 battery cells 60 are sandwiched in the front-rear direction by the cushioning material 77 at the front which contacts the inner surface of the front wall portion 24 and by the cushioning material 77 at the rear which contacts the inner surface of the rear wall portion 25. Further, a left end portion of each battery cell 60 is positioned between the connection portion 30 and the connection portion 40, and a right end portion of each battery cell 60 is positioned between the connection portion 35 and the connection portion 45. Furthermore, the thickness changing portion 60TG1 of the battery cell 60 positioned at the frontmost side contacts the inner surface 31, and the thickness changing portion 60TG2 of the battery cell 60 positioned at the frontmost side contacts the inner surface 36. Further, the thickness changing portion 60TG1 of the battery cell 60 positioned at the rearmost side contacts the inner surface 41, and the thickness changing portion 60TG2 of the battery cell 60 positioned at the rearmost side contacts the inner surface 46. Therefore, the thickness changing portions 60TG1 and 60TG2 of the plural battery cells 60 positioned at the front side and the rear side are bent by the connection portions 30, 35, 40, and 45. In this regard, of the 24 battery cells 60, the battery cell 60 positioned at the frontmost side is referred to as a battery cell 60F, and the battery cell 60 positioned at the rearmost side is referred to as a battery cell 60R. The thickness changing portions 60TG1 and 60TG2 of the battery cell 60F are directly pressed by the connection portions 30 and 35, and the thickness changing portions 60TG1 and 60TG2 of the battery cell 60R are directly pressed by the connection portions 40 and 45. Therefore, the bending amounts of the thickness changing portions 60TG1 and 60TG2 of the battery cells 60F and 60R are greater than the other battery cells 60. When the thickness changing portions 60TG1 and 60TG2 of the battery cell 60 are bent, a force corresponding to the bending amount thereof reaches the first region AR1, the second region AR2, the fourth region AR4, and the fifth region AR5 of the laminated body, respectively. Therefore, it is preferable that the deformation amounts (bending amounts) of the thickness changing portions 60TG1 and 60TG2 of the battery cell 60 are small.

As described above, the thickness T of the thickness changing portion 60TG1 of the battery cell 60F when viewed in the up-down direction gradually decreases toward a distal end portion (positive electrode terminal 61A) side. Further, the thickness changing portion 60TG1 of the battery cell 60 F contacts the inner surface 31 of the connection portion 30. As described above, the radius of curvature RP of the inner surface 31 which is centered on the corner portion 20A when viewed along the up-down direction gradually decreases from the front wall portion 24 side toward the left side wall portion 26 side. Therefore, compared to a case in which a radius of curvature RP of the inner surface 31 is constant in the entire area of the inner surface 31, a force that reaches the thickness changing portion 60TG1 of the battery cell 60F from the connection portion 30 (the inner surface 31) is smaller. As a result, although a force that is greater than a force reaching the thickness change portion 60TG1 of the battery cells 60 (excluding the battery cell 60R) positioned at the rear side of the battery cell 60F reaches an interior of the thickness change portion 60TG1 of the battery cell 60F, there is less risk of a short circuit occurring in the battery cell 60F due to the end portion 62B of the negative electrode sheet 62 contacting the positive electrode sheet 61 while penetrating the separator 64, at an interior of the laminate film 67 of the battery cell 60F.

Similarly, the thickness changing portion 60TG2 of the battery cell 60F contacts the inner surface 36 of the connection portion 35. The radius of curvature of the inner surface 36 centered on the corner portion 20B when viewed along the up-down direction gradually decreases from the front wall portion 24 side toward the right side wall portion 27 side. Therefore, compared to a case in which the radius of curvature of the inner surface 36 is constant in the entire area of the inner surface 36, a force that reaches the thickness changing portion 60TG2 of the battery cell 60F from the connection portion 35 (the inner surface 36) is smaller.

The thickness changing portion 60TG1 of the battery cell 60R contacts the inner surface 41 of the connection portion 40. The radius of curvature of the inner surface 41 centered on the corner portion 20C when viewed along the up-down direction gradually decreases from the rear wall portion 25 side toward the left side wall portion 26 side. Therefore, compared to a case in which a radius of curvature of the inner surface 41 is constant in the entire area of the inner surface 41, a force that reaches the thickness changing portion 60TG1 of the battery cell 60R from the connection portion 40 (the inner surface 41) is smaller. Similarly, the thickness changing portion 60RTG2 of the battery cell 60R contacts the inner surface 46 of the connection portion 45. The radius of curvature of the inner surface 46 centered on the corner portion 20D when viewed along the up-down direction gradually decreases from the rear wall portion 25 side toward the right side wall portion 27 side.

Therefore, compared to a case in which a radius of curvature of the inner surface 46 is constant in the entire area of the inner surface 46, a force that reaches the thickness changing portion 60TG2 of the battery cell 60R from the connection portion 45 (the inner surface 46) is smaller.

It should be noted that in order to reduce force that reaches the thickness changing portions 60TG1 and 60TG2 of the battery cells 60F and 60R from the connection portions 30, 35, 40, and 45, it is preferable that the size of the radius of curvature of each portion (predetermined portion) of the inner surfaces 31, 36, 41, and 46 is greater than or equal to a dimension obtained by multiplying a thickness of respective portions of the thickness changing portions 60TG1 and 60TG2, in contact with each portion (predetermined portion), by 0.5. For example, it is preferable that a radius of curvature RP (mm) of a predetermined portion 31P at the inner surface illustrated in FIG. 7 is greater than or equal to a value obtained by multiplying a thickness TP (mm) of the portion, at the thickness changing portion 60TG1 of the battery cell 60F, which is in contact with the predetermined portion 31P by 0.5.

Further, 24 battery cells 60 are sandwiched in the front-rear direction by the front cushioning material 77 that is in contact with the inner surface of the front wall portion 24 and the rear cushioning material 77 that is in contact with the inner surface of the rear wall portion 25. This enables each battery cell 60 to be restrained from vibrating inside the case 15 by the front and rear cushioning materials 77. Further, thermal expansion and thermal contraction of the battery cells 60 can be absorbed by the front and rear cushioning materials 77.

Although explanation has been given above regarding the battery module according to exemplary embodiments, the battery module according to exemplary embodiments can be appropriately modified in design within a scope that does not depart from the gist of the present disclosure.

For example, the connection portion 30 may be configured such that the radius of curvature RP of the inner surface 31 centered on the corner portion 20A when viewed along the up-down direction is gradually reduced from the front wall portion 24 side toward the left side wall portion 26 side, only in a partial region of a region between an end portion at the front wall portion 24 side of the inner surface 31 and an end portion at the left side wall portion 26 side of the inner surface 31. That is, the curvature changing portion may be formed only at a partial region of the inner surface 31.

Similarly, a curvature changing portion may be formed only at a partial region of the inner surface 36, a curvature changing portion may be formed only at a partial region of the inner surface 41, or a curvature changing portion may be formed only at a partial region of the inner surface 46.

The battery module 11 may be installed at the vehicle 100 in such a manner that the lid body 50 is orthogonal to the left-right direction.

What is claimed is:

1. A battery module, comprising:
a case that includes a pair of first walls that are separated in a predetermined first direction, a pair of second walls that are separated in a second direction that is orthogonal to the first direction, and four connection portions that respectively connect end portions of adjacent ones of the pair of first walls and the pair of second walls; and
a plurality of laminated battery cells that are accommodated, in a state of being side-by-side in the first direction, in a space enclosed by the pair of first walls, the pair of second walls, and each of the connection portions, and that extend along the second direction,
wherein an inner surface of each connection portion is a curved surface that is convex toward the space when viewing the case along an orthogonal direction that is orthogonal to the first direction and the second direction, and at least a part of the curved surface is a curvature changing portion at which a radius of curvature gradually decreases from the first wall side toward the second wall side, and
wherein a battery cell that is positioned furthest toward the first wall side includes a portion that contacts the curvature changing portion when viewing the case along the orthogonal direction.

2. The battery module according to claim 1, wherein:
the portion of the battery cell that is positioned furthest toward the first wall side, which contacts the curvature changing portion, is a thickness changing portion having a thickness that decreases toward the second wall side when viewing the case along the orthogonal direction.

3. The battery module according to claim 1, wherein:
a size of the radius of curvature at a predetermined portion of the curved surface is greater than or equal to a dimension obtained by multiplying a thickness of the portion of the battery cell which contacts the predetermined portion by 0.5.

4. The battery module according to claim 1, wherein:
an entirety of the curved surface is the curvature changing portion.
